(19) United States
(12) Patent Application Publication
(10) Pub. No.: US 2009/0068611 A1
(43) Pub. Date: Mar. 12, 2009

(54) Orthodontic elastic apparatus

(76) Inventor: Sergio Zanghellini, Samone (IT)

Correspondence Address: ALBERTO Q. AMATONG, JR., P.O. BOX 70889, HOUSTON, TX, 77270-0889, US

(21) Appl. No.: 11/919,954

(22) PCT Filed: Apr. 28, 2006
(86) PCT No.: PCT/EP2006/061939

§ 371 Date: Nov. 5, 2007

(30) Foreign Application Priority Data
May 5, 2005 (IT) TN2005A0006

(51) Int. Cl. A61C 7/00

(52) U.S. Cl. 433/18

(57) ABSTRACT

Apparatus for applying orthodontic elastics to brackets, including a container having a tube shaped member for housing said elastics in a predetermined position and/or orientation, said external side of the tube-shaped member carrying thereon a plurality of elastics, a release mechanism for selectively releasing an elastic from the container to an elastic placer positioned relative to said elastic housing to receive an elastic from said elastic container, said elastic placer having at least two rods sliding in use along said internal side of the tube-shaped member, said rods causing a first automatic inward-converging movement of the extremities of said rods respect said tube-shaped member in order to automatically receive an elastic from said elastic container, a second automatic outward-diverging movement of the extremities of said rods in order to automatically expand and apply said elastic directly to a bracket.

### FIELD OF THE INVENTION AND BACKGROUND ART

The present invention relates to an apparatus for storing, preserving and marketing, in proper hygienic conditions, orthodontic elastics necessary for the application of orthodontic appliances to the teeth.

Orthodontic appliances are commonly used to align and or rotate the teeth to the correct position. Orthodontic brackets or braces, (hereinafter referred to as brackets), are applied on the teeth to support and direct the necessary corrective force and torque actions. The common procedure to apply the brackets starts with the eroding of each tooth surface on which the brackets will be applied by means of an acid substance. After the relevant time the acid is removed, usually by means of air-water blasts, and then the teeth are ready for application of the brackets. The brackets are applied one at a time and, using a glue dispensers or the like, glue is applied to the bracket and then the bracket is applied and properly positioned on the tooth by means of a tweezers or the like. The same procedure is followed for each individual bracket and once all are applied on all the designated teeth, they are connected together by means of metallic wire or the like provided for the purpose, placing and fixing the wire on the bracket seats by means of elastics or metallic ligatures, to generate the desired corrective force and torque actions on the teeth. Elastics are usually colored and o-ring shaped.

Brackets have usually a base, a body protruding form said base and at least two tiewings extending away from said body in a gingival or/and occlusal direction. In particular, said tiewings and the body of the bracket are such to create a recess on the bracket's sides. The elastic is placed on the bracket into said recesses in such manner to hold the metallic wire in position.

Said elastics are applied one by one, usually grabbing them with the fingers or by means of a tweezers or the like from a container. Elastics are usually kept loose into said container or threaded in a wire closed at the ends, or taken off from an elastic block where they are attached, said block made also of the same elastic material.

To take off the elastic from said block, or to unthread it from the wire or to take it out from said container, it is usually used fingers or tweezers or the like, usually properly hooked at the scope to hold the elastic.

The elastic is than positioned in one or more of the recesses that are on one side of the bracket and than said elastic is pulled by means of the tweezers or the like to engage to the recess/es on the other side of the bracket.

Conventional instruments and methods, however, have their respective drawbacks. For example, when an elastic is to be pulled out from the elastic container or the like and applied on the designated bracket, it is difficult to grab, take off, hold and pull out each individual elastic as well as to release and place it on the designated bracket. In this case, there is the above mentioned risk with the related consequences and also a statement of fact that existing instruments and the like are not user-friendly and do not allow any possible automation of the elastic application to brackets.

The conventional method is based on a variety of many elementary instruments, and the like as above mentioned, and is also based on many containers, dispensers, and the like, for elastics. This means that, to apply the elastics to the brackets, much time is required and there is also an increased risk of each individual elastic being dropped during the various phases and passages before it is finally applied to the bracket.

Instruments such as common tweezers for placing the elastics are not user friendly and are not helpful for engaging the elastic to the bracket's recesses. Said instruments entail much time, cost and trouble to perform the elastic application, causing much inconvenience to the patient and to both the doctor and his/her assistants. This is mainly due to the manual skills, work effort and low efficiency that are implied with the existing instruments. There is a high risk that an elastic may be accidentally dropped with consequent loss, increased elastic handling, impaired cleanliness and time lost in general.

### GENERAL DESCRIPTION OF THE INVENTION

The invention has been made in consideration of the above mentioned problems and it is embodied in apparatus to house the elastics and to automatically or semi-automatically release elastics from an elastic container and to apply and position them on the brackets with high accuracy, a good degree of reliability and in a low time-consuming fashion, avoiding to touch the elastic with the fingers.

In order to alleviate the above-mentioned problems, according to a first aspect of the invention there is provided apparatus for storing orthodontic elastics, said elastics being all of one specific or different colors, such to preserve the elastics in a predetermined position and/or orientation and in perfect hygienic conditions into an elastic container, including a release mechanism for selectively releasing an elastic from the container to an elastic placer for applying the elastic directly to a bracket. Preferably, the elastic container and the elastic placer and/or other apparatus herein described being part of the same device.

The elastic container is designed to house the elastics, preferably in a set position and orientation so that release of the elastics from the container is facilitated and is more controlled. The elastic placer provides to the elastic expansion as necessary and to release than the elastic in order to engage to the recesses of the bracket and obviates the need for tweezers and other instruments as the apparatus enables an elastic to be automatically or semi-automatically transferred from the container to a bracket without need for a user to arrange the correct position and/or orientation for each elastic.

Preferably, the apparatus further comprises retaining means for retaining the elastics in the container so as to retain the elastics in said predetermined position and/or orientation until they are selectively released from the container. In a preferred form, said release mechanism includes means for isolating one of said elastics from the others, and means for pushing said isolated elastic along a trajectory to reach said elastic placer. In particular, said retaining means can be adapted to simultaneously retain the other elastics, in order to retain them inside the container. This means that the alignment of the elastics remaining within the container is not disrupted by one of the elastics being released for application to a bracket.

Said release mechanism releases the elastics, in use, sequentially from said container along a substantially linear or a curvilinear trajectory. Advantageously, said container is substantially linear or curvilinear and wherein the elastics are biased forwardly by a spring or the like against the extremities of a set of rods so that said elastics are aligned on a substantially linear or curvilinear trajectory and are retained in said predetermined position and/or orientation until selectively released from the container. Furthermore, said release mechanism may include a push button, wherein application of force to the push button causes deformation of said set of rods and movement of the extremities thereof so as to permit passage of an elastic therethrough.

Possibly, said retaining means comprises a set of rods on which a push button is mounted and the application of force to the push button causes movement of said set of rods so as to limit forward movement of the elastics behind the elastic currently being released.

In an alternative embodiment, said release mechanism releases the elastics, in use, sequentially from said container by means of the force of gravity, pressured air or gas in general, springs or deformation of parts in general.

Preferably, said apparatus is a disposable tool or, alternatively, the container is loadable with said elastics one by one or, by means of a pre-loaded cartridge containing a predetermined number of elastics.

Preferably, said apparatus and the cartridge/s may be separated or parts of a single device.

Preferably, the elastic placer and in particular the parts are in contact with the teeth, may be interchangeable for new and clean parts or for cleaning of the same parts until they are reused for the next application.

Preferably, said apparatus includes features to facilitate the alignment, orientation and the relative position between the bracket and the elastic placer to guarantee the correct application of the elastic to the bracket and to not drop the elastic.

Preferably, the elastics are kept along a substantially linear or curvilinear trajectory including the case where said curvilinear trajectory has the scope to create a proper angle in order to facilitate the elastic application to brackets are not easily accessible.

Preferably, the apparatus includes transparent parts to facilitate the identification of the elastics, the type, color and the quantity of the elastics are into the apparatus and/or into the cartridge.

Preferably, said release mechanism and said elastic placer are part of a single device.

In a further preferred form, said container is part of said single device. Alternatively, said container is separate from said single device. In this embodiment, preferably, the separate container includes means for storing each individual elastic, in an orientation ready for interfacing with said elastic placer, in use, and so that each elastic may be retrieved independently from the container by the elastic placer. In case, the elastics can be stored in a matrix formation.

In a preferred form, the apparatus further comprises means for centering, aligning and properly position the elastic placer to a bracket surface for an optimized engagement of the elastic to recesses of the bracket.

In one embodiment, said means is part of said container and/or elastic placer and whereby, in use, the elastic can be applied to a bracket automatically upon retrieval of said elastic from the container.

Preferably, the apparatus further comprises a centering-position-aligning device for centering, aligning and adjusting the position and/or orientation of an elastic before applying it to a bracket. In a preferred form, said centering-position-aligning device comprises at least one spacer, which is designed to contact an edge of a bracket so that it is possible to properly position an elastic at a set distance from the edge of said bracket.

According to a second aspect of the invention, there is provided a container for use in apparatus as described in the preceding paragraphs including means for storing each individual elastic, in an orientation ready for interfacing with said elastic placer, in use, and so that each elastic may be retrieved independently from the container by the elastic placer.

According to a third aspect of the invention, there is provided a disposable elastic applicator kit containing all apparatus necessary for the storage and application of elastics, the apparatus being as described in any of the preceding paragraphs.

According to a fourth aspect of the invention, there is provided a disposable elastic applicator kit including a container for housing said elastics in a predetermined position and/or orientation, a release mechanism for selectively releasing an elastic from the container, an elastic placer for applying the elastic directly to a bracket, and one or more of the following:
a retaining means for retaining the elastics in the container so as to retain the elastics in said predetermined position and/or orientation until they are selectively released from the container;
means for isolating one of said elastics from the others, and means for pushing said isolated elastic along a trajectory to reach said elastic placer;
a centering-position-aligning device for centering, aligning and adjusting the position and/or orientation of an elastic before applying it to a bracket.

### DESCRIPTION OF THE DRAWINGS

These and other objects and features of the present invention will become clear from the following description, given by way of example only and with reference to the accompanying drawings, throughout which like parts are designated by like reference numerals, and in which:

FIG. 1 is a section view of a first embodiment of the apparatus showing a chassis (4a), the tube-shaped elastic housing of the elastic container (5a), elastics (13a), a carter (2a), the releasing device with the push button and relative cams (9a) in order to maintain different permanent and stable positions while the button is not being pushed, the cover (8a), the press-spring plunger (7a) and the spring (6a). It is further shown the holding wings (3a) and the safety cover (1a).

FIG. 2 is a section view of the apparatus of the first embodiment showing part of the elements shown in FIG. 1 and the apparatus positioned relative to the bracket (12a) already applied to the tooth (11a).

FIG. 3 is a section view of the apparatus of the first embodiment showing in particular the tooth (11a), the bracket (12a) that is going to receive the elastic (13a), the tube-shaped elastic housing of the elastic container (5a) and in particular the holding-releasing device (17a) and some of its parts like some of the expanding rods (15a) and (14a) and the optional retrieving rod (16a).

FIG. 4 is a front view of the apparatus of the first embodiment showing the apparatus without the safety cover and in particular showing the expanding rods (15a), (14a), (20a), (21a) and their optional radial parts like the (22a) and (23a) of the rod (14a). It is also shown the optional retrieving rod (16a), the elastic (13a) held by means of the expanding rods, the carter (2a) and the holding wings (3a).

FIG. 5 is a section view of the apparatus of the first embodiment showing the tooth (11a), the bracket (12a), the elastic (13a) expanded by means of the expanding rods (15a), (14a), said elastic in position to be released and applied to the bracket, the tube-shaped elastic housing of the elastic container (5a) and in particular the holding-releasing device (17a) and some of its parts like the expanding rods (14a) and (15a) in expanded position and the optional retrieving rod (16a).

FIG. 6 is a front view of the apparatus of the first embodiment showing the apparatus without the safety cover and in particular the expanding rods (15a), (14a), (20a), (21a) and their optional radial parts like the (22a) and (23a) of the rod (14a). It is also shown the optional retrieving rod (16a), the elastic (13a) held and expanded by means of the expanding rods, said elastic in position to be released and applied to the bracket, the carter (2a) and the holding wings (3a).

FIG. 7 is a section view of the apparatus of the first embodiment showing the tooth (11a), the bracket (12a), the elastic (13a) expanded by means of the expanding rods (15a), (14a), said elastic in position to be released and applied to the bracket, the tube-shaped elastic container (5a) and in particular the holding-releasing device (17a) and some of its parts like the expanding rods (14a) and (15a) in expanded position and the optional retrieving rod (16a) and in particular the optional retrieving elements (18a) and (19a) respectively part of the rod (15a) and (14a).

FIG. 8 is a section view of a second embodiment of the apparatus showing a chassis (2b), a container (33b) of elastics (13b), the cover (8b), the holding-releasing device with the push button (30b), the expanding rods (15b), (14b), the holding rods (39b) (40b), the fulcrums ((28b) (29b) of the expanding rods and the pressure elements (32b) (31b) such to transfer the pressure acting on the push button and than on the expanding rods also to the holding rods. It is also shown the safety cover (1b).

FIG. 9 is a section view of a second embodiment of the apparatus showing parts of the devices and elements shown on FIG. 8.

FIG. 10 is a front view of the apparatus of the second embodiment showing the apparatus without the safety cover and in particular showing the expanding rods (15b), (14b), (20b), (21b) and their optional radial parts like the (22b) and (23b) of the rod (14b). It is also shown the elastic (13b) held by the expanding rods, the chassis (2b), the push button (30b), the pressure elements (32b) (31b) (37b) (38b) and the holding points (34b) (35b) (36b).

FIG. 11 is a section view of the apparatus of the second embodiment showing the tooth (11b), the bracket (12b), the elastic (13b) expanded by means of the expanding rods (15b), (14b), said elastic in position to be released and applied to the bracket, the elastic housing of the elastic container (33b), the chassis (2b) and in particular the holding-releasing device and some of its parts like the expanding rods (15b) (14b) shown in expanded position and the holding rods (39b) (40b) and the fulcrums (28b) (29b), the button (30b) and the pressure elements (32b) (31b).

FIG. 12 is a front view of the apparatus of the second embodiment showing the apparatus without the safety cover and in particular showing the expanding rods (15b), (14b), (20b), (21b) in expanded position and their optional radial parts like the (22b) and (23b) of the rod (14b). It is also shown the elastic (13b) held and expanded by means of the expanding rods in position to be released and applied to the bracket, the chassis (2b), the push button (30b), the pressure elements (32b) (31b) (37b) (38b) and the holding points (34b) (35b) (36b).

FIG. 13 is a schematic view from a distal or mesial point of observation showing a bracket (12) applied to a tooth (11), parts of the bracket like the tie wings (28) (29) and the base (30). It is also shown the elastic (13) applied to the bracket.

FIG. 14 is a section view of the apparatus of the first embodiment showing the tooth (11a), the bracket (12a), the elastic (13a) held by means of the blocks (24a) (25a) as to limit forward movement of the elastics to the tooth direction. It is also shown the elastic placer device when the elastic is not loaded on said elastic placer device.

FIG. 15 is a section view of the apparatus of the first embodiment showing the elastic (13a) free to move forward until it is being blocked by means of the blocks (26a) (27a), said forward movement allowed due to the missing blocking action of the blocks (24a) (25a), said missing blocking action being absent due to the expanding rods retrieved inside the tube-shaped member of the elastic container (5a).

FIG. 16 is a section view of the apparatus of a possible embodiment showing some optional elements like the centering-position-aligning device (16b) in order to properly and correctly center, position and align the apparatus and in particular the elastic relative to the bracket before and in action when the elastic is released and applied to the bracket. It is also shown the optional case where the elastics (13b) are pushed to the elastic placer devise by means of a spring (43b). It is also shown the optional case of the second embodiment where the push button (30b) is being activated moving said push button in direction of the bracket or in the opposite direction so that said push button does not push any longer the pressure elements (31b) (32b) while, if not moved in said directions, said push button acts a pressure on the pressure elements and/or vice versa.

FIG. 17 is a section view of a possible cartridge carrying the elastics where said elastics are stored in the elastic housing of the container (1c) closed by means of the cover (4c).

FIG. 18 is a section view of another possible cartridge carrying elastics where said elastics are threaded on the rod (33d) of the elastic housing and closed at the extremities by means of the covers (1d) and (8d).

FIG. 19 is a section view of a possible safety cover (1e) including a pad (31e) with proper substance for an hygienic conservation of elastics, elastic placer and elastic container, before, in use and until the next elastic application.

### DETAILED DESCRIPTION OF SOME EMBODIMENTS OF THE INVENTION

Hereinafter embodiments of the invention will be described, by way of example, referring to the appended drawings.

The apparatus of the invention is apparatus for applying orthodontic elastics to the brackets, generically referred to below as an “automatic elastic placer”. The apparatus is preferably provided with a chassis and a plurality of “devices”, hereinafter described in more detail, and which include a “container-dispenser device”, a “holding-releasing device”, an “elastic placer device, a “centering-position-aligning device”, and a “cartridge”.

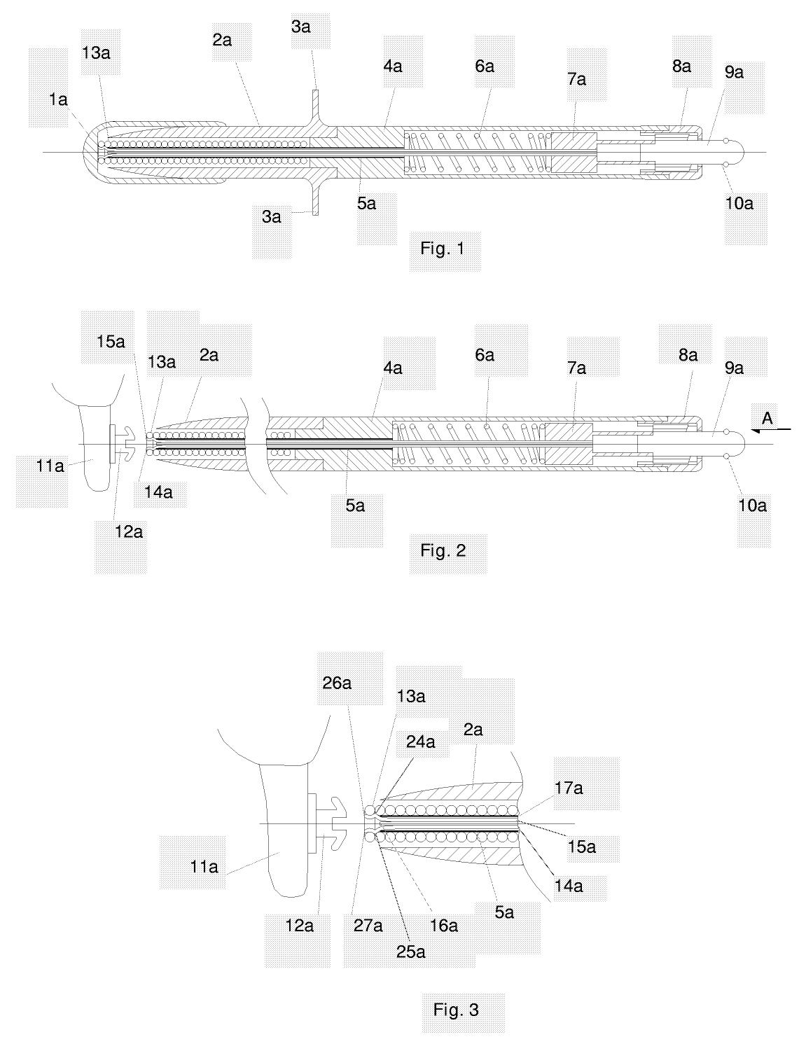

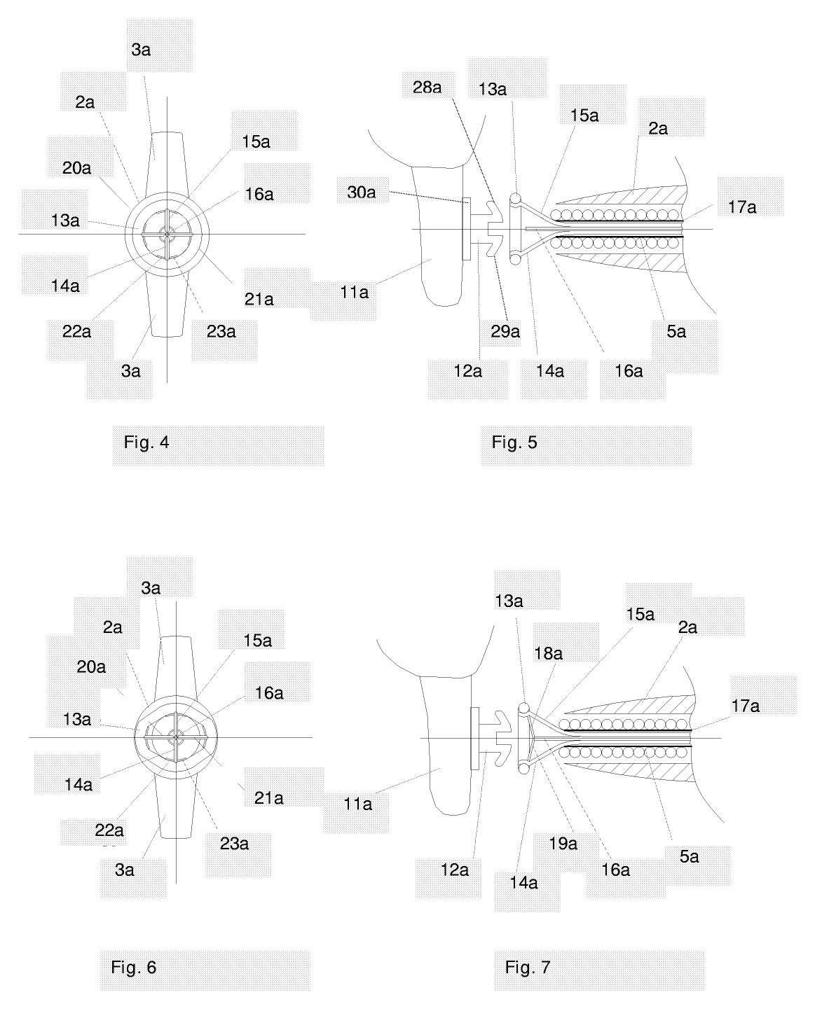

A first embodiment of the invention is shown in FIG. 1. The elastics (13a), generally o-ring shaped made of colored elastic material, are housed in the apparatus into a container housing one or a plurality of elastics. Said elastic container is realized by means of a tube-shaped member (5a) of whatever section and shape suitable at the scope, preferably circular or elliptical. In general, said tube-shaped member having an external and an internal side, said external side of the tube-shaped member carrying thereon a plurality of elastics. On the external side of said tube are threaded the elastics (13a) so that said elastics are free to move forward along the tube if pushed by means designed for the purpose to move said elastics like springs, as shown in FIG. 16, or by pressured air or gas in general, or simply by the force of gravity like in FIG. 1 where the elastics are moving forward sliding down along said tube shaped member when the tube is in vertical or almost vertical position. The container includes means in order to retain the elastics in the container until it is required to be released. In FIG. 1 the elastics are not allowed to exit from the container since, on one extremity of the tube, a barrier like the chassis (4a) physically dos not allow the elastic to move forward any more to said direction. On the other extremity of the tube the elastic is blocked by the holding-releasing device (17a) and in particular by the expanding rods, hereinafter also referred to as rods, (15a) (14a) (20a) (21a) shown in FIG. 4. Said rods are sliding along the internal side of the tube-shaped member and, said rods, have the free extremities extending beyond the end of said tube-shaped member, said expanding rods properly shaped and positioned in order to physically block the elastics, not allowing them to move forward as shown in FIG. 3, 5, 7, 14 and FIG. 15 by means of the blocks (24a) (25a) (26a) (27a) shown in particular in FIG. 14 and FIG. 15.

The holding-releasing device (17a) releases upon an input elastics to the elastic placer device. Said holding-releasing device comprises barriers that physically does not allow the elastics to exit from the container. In this specific case said barriers are realized by one (15a) (14a) or more of the expansion rods as shown in FIGS. 3 and 14, said expansion rod such to physically block elastics by the blocks (24a) (25a). Said barrier/s hereinafter referred also as to block/s, can be removed upon an input like shown in FIG. 15 in order to allow elastics to move by means of a pushing action due to springs, air pressure or gas in general, the force of gravity or other actions able to move forward the elastics. In this specific case, upon an input, the expansion rods retract sliding into the tube retracting by a converging movement also the block/s (24a) allowing, as shown in FIG. 15, the elastics (13a) to move forward sliding, for instance by gravity. At the same time the extremity of one or more of the expanding rods include other barrier/s (26a) (27a) that physically block elastics to move any further along that direction, and, in this case, the elastic results loaded in the elastic placer device ready to be positioned and applied upon an input to a bracket while the other elastics are safely held in the elastic container.

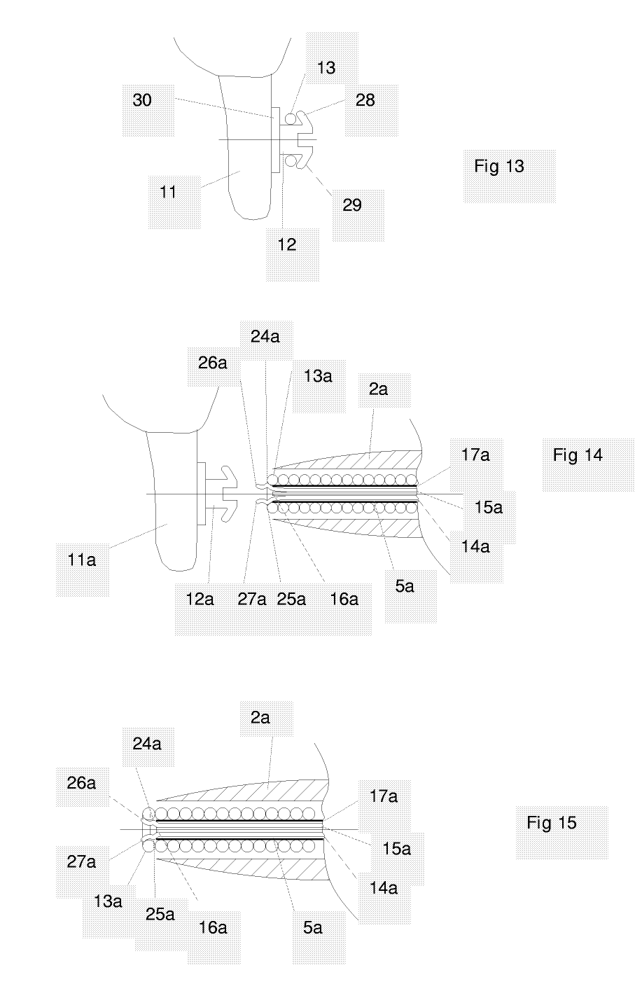

The elastic placer receives said elastics from the elastic container, said elastic placer realized by the expanding rods and optionally by the retrieving rod (16a) and/or the retrieving elements (18a) ( 19a) as shown in FIG. 7 for each expanding rod, said rods sliding into the tube-shaped member. An outward diverging movement of the extremities of the expanding rods is generated upon an input, expanding or moving outward said extremities as to cause the elastic to be moved forward to the bracket and the expansion of the elastic as shown in FIGS. 5 and 7 as necessary to allow said elastic (13a) to engage to the recesses of the bracket (12a), said recesses shaped between the base (30a) and/or body of the bracket and the tie wings (28a) (29a) of the bracket. While said elastic is being expanded, the other elastics are held into the elastic container by the block/s realized in this case by the expanding rods themselves as shown in FIGS. 5 and 7. The expanding action of the expanding rods is against the retrieving action of the elastic which, expanding, accumulates elastic energy and elastically bends also the expanding rods until a limit configuration is reached where all expanding and retrieving actions are balanced and than the expanded elastic can not be held any further by the expanding rods themselves. In this position, the elastic is being expelled to the bracket direction engaging with the recesses between body and/or base (30a) and the tie wings (28a) (29a) of the bracket (12) as shown, for instance, in FIG. 13 while all other elastics are kept in the elastic container. In case, if needed, the retrieving action of the expanding rods may be helped by means of the retrieving elements shown in FIG. 7 (18a) (19a) so that each expanding rod is retrieved by the combined action of the elastic and of the retrieving elements.

Once the elastic has been expelled, the expanding action or movement of the extremity of the expanding rods stops and starts an inward converging movement of said extremities and, in addition, the expanding rods retrieve back sliding into the tube as shown in FIG. 14. The expanding rods may automatically or semi automatically upon an input proceed the retrieving action or/and movement into the tube in order to allow the next elastic to move forward to the position shown in FIG. 15 so as to permit said next elastic to be loaded in the elastic placer device as shown in FIG. 3, said next elastic being ready to be applied to the next bracket and so on, sequentially, elastic by elastic is being applied to all brackets. The expanding-retrieving action of the expanding rods, in a preferred version of the embodiment, may be obtained by the expanding-retrieving mechanism shown in FIGS. 1 and 2. The expanding rods (15a) (14a) and (20a) (21a) have the other extremity anchored, in (A) direction and the opposite direction, to the plunger, hereinafter also referred as to piston (7a), said plunger being anchored in (A) direction and the opposite direction, to the push button (9a) or, alternatively, said plunger and the push button may form only one component. By means of the combined action of the spring (6a), cams built in the push button (8a) and/or on the chassis (4a) and/or on the cover (8a), pushing said button and/or allowing it to return back by means of the action of the spring, said push button can slide to (A) direction or to the opposite direction, said button reaching one or more positions along (A) direction or the opposite direction maintaining said positions stably and permanently until said button is not being pushed again. In addition, said button can reach one or more other positions along (A) direction or the opposite direction and maintain said other positions as long as the button is held pressed, for instance by finger pressure, reaching the highest and lowest ending positions, each one of said ending positions changing to one of the previous stable and permanent positions as soon as the pressing action on the button is removed. Said one or more stable and permanent positions and/or temporary positions are corresponding to the various positions of the expanding rods and of the barriers/blocks as previously described to permit the outward diverging and inward converging movements of the extremities of said rods and the related holding and releasing action and movement of the elastic from the container to the elastic placer and receiving of the elastic by the elastic placer and subsequent expulsion and application to the bracket, loading other elastics in the elastic placer and so on, applying elastics to brackets, sequentially, elastic by elastic, in an automatic or semiautomatic manner. The optional retrieving rod (16a) may help, in this case, also as spacer in order to define, by contact to the bracket, the correct distance and to center, position and align the apparatus, the elastic placer and, in particular, the elastic, to the bracket while said elastic is being applied to the bracket resulting in an easier and reliable elastic application. This embodiment shows in FIG. 1 the elastics in the container kept and moving along a substantially linear trajectory but, not shown in any of the figures, it may be instead in an other preferred embodiment, a substantially curvilinear trajectory so that the ending part of the elastic placer results angled respect the (A) direction in FIG. 2, said angle allowing to easily reach those brackets that presents a more difficult access.

The optional holding wings (3a), shown in FIGS. 1, 4, 6 help the ergonomic handling and functionality of the apparatus so that it can be used similar to a syringe by pressing the push button (9a).

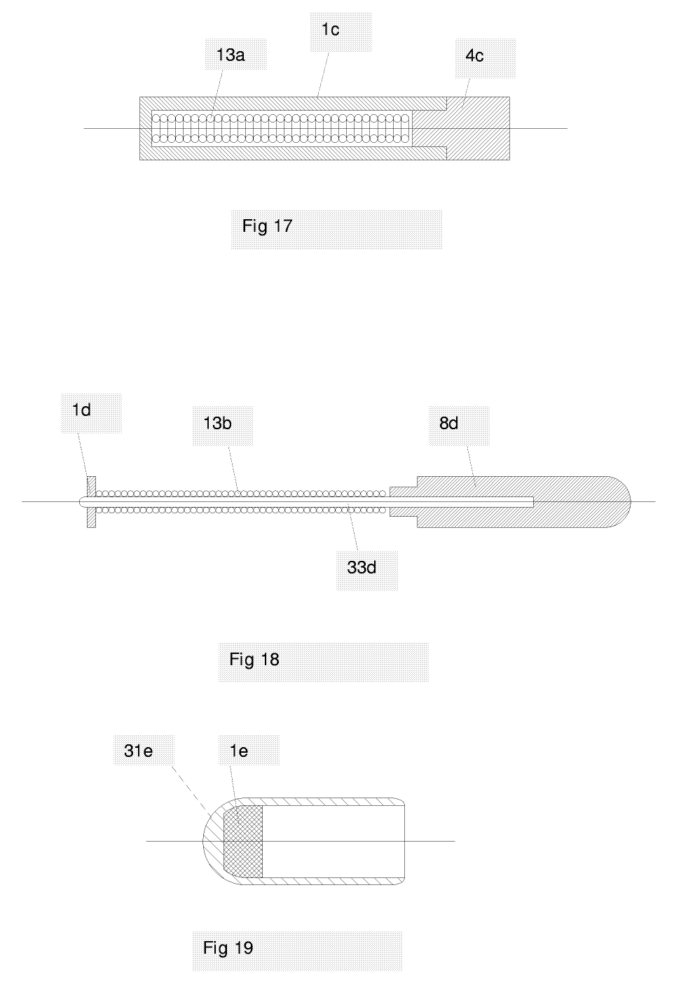

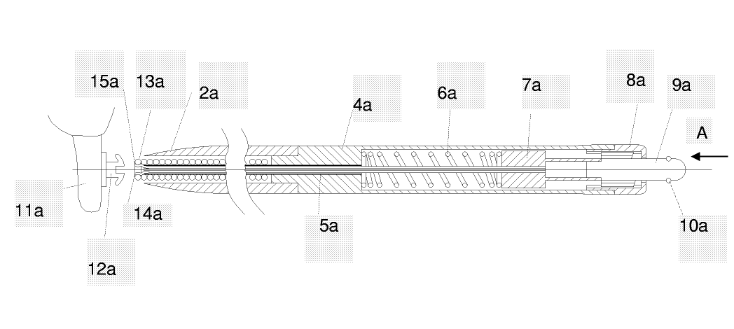

In addition. As shown in FIG. 6, the expanding rods can expand the elastic keeping an elliptic shape with a bigger elongation along a mesial-distal direction or gingival-occlusal direction or even other direction as it may be more convenient or, alternatively, the elastic can be expanded maintaining a substantially circular shape, said expansion shape depending on the shape of the bracket and of the tie wings (28) (29) of the bracket. In addition, if needed, as shown in FIGS. 4, 6, each or part or all expanding rods may comprise radial elements (22a) (23a) such to better maintain the elliptic or circular elastic shape during the expansion of said elastic. The apparatus may include also a safety cover (1a) as shown in FIG. 1 in order to avoid to accidentally drop or/and expel an elastic and/or to preserve them and the apparatus in hygienic conditions during transportation, storage, and when it is not used in general. In addition, said safety cover may include a dispenser of proper hygienic and/or cleaning substance as, for instance, the pad shown in FIG. 19 impregnated of said substance or, alternatively, not shown in any figure, said dispenser may be obtained by a proper container containing said substance which can be dispensed by one or more nozzles, said substance to maintain in the due hygienic conditions the expanding rods, the blocks, the elastic placer device and the elastics in the case that said apparatus is used for more and different applications and/or in different moments. In addition, the apparatus may be disposable or, in an other preferred version, may be reloadable by means of cartridge/s, said cartridge/s housing a plurality of elastics that can be preloaded or reloadable of elastics. A preferred version of cartridge may be obtained observing FIG. 1. In particular, an example of a cartridge may be obtained using the safety cover (1a) and the carter (2a) and a cartridge cover to close it to not allow any elastic (13a) to exit, similar to the action of the chassis (4a). To load said cartridge in the apparatus it has to be removed from the apparatus the assembly realized by the safety cover (1a) and the carter (2a) from the chassis (4a) and, after that, it has to be engaged the cartridge to the apparatus and in particular to the chassis (4a) so that the cartridge becomes the new safety cover (1a) and carter (2a) as in FIG. 1. Alternatively, a cartridge may be realized looking FIG. 17 where the carter and the safety cover are forming only one part (1c) to house the elastics. In this case to load the elastics into the apparatus is necessary to remove the safety cover (4c) of the cartridge shown in FIG. 17 and the apparatus, without the carter (2a) and the cover (1a), is driven through the cartridge so that the tube (5a) threads one by one all elastics loading, in such a way, the elastics into the elastic container of the apparatus. After that, mounting the carter (2a) and the safety cover (1a), is obtained again the apparatus shown in FIG. 1, ready for next use. Alternatively, a cartridge may be realized looking FIG. 18 where the elastics are threaded by the rod (33d) and blocked at the extremities of said rod by the cover (1d) and (8d) where, if needed, the cover (1d) may be the cover (1c) shown in FIG. 17. In this cases, to load the elastics in the apparatus, it must be removed the assembly realized by the carter (2a) and the cover (1a) and than the cartridge is driven through the apparatus and in particular through the container and, after that, proceeding as described before, using the obtained assembly like described for the cover (1c) in FIG. 17, to load the elastics into the container of the apparatus.

In addition, said apparatus may be, in general, made of any suitable material and/or color including also the case where all or part may be transparent so that it is possible to see if the apparatus or/and the optional cartridge houses elastics, how many, type and color of said elastics as well. The push button (9a), in case, may eventually include as shown in FIG. 1 an elastic housed in the slot (10a) or, more in general, the apparatus itself may include colored parts and/or numbers with the purpose to identify the type and color of the elastics.

In an alternative version of the first embodiment, not shown in any drawing, the functionality of the barrier/s (24a) (25a) (26a) (27a) of the expanding rods (15a) (14a) (20a) (21a) and related holding-releasing mechanism and push button of the apparatus to move release and hold the elastics described in the first embodiment, may be realized by means of rods retrieved, expanded and pushed by pressured air or gas in general or in combination with spring/s such to create the retrieving action and the related inward converging movement of said rods while the pressured air or gas creates the expanding action and the related outward diverging movement of said expanding rods or vice versa.

In addition, the action of the barrier/s and of the expanding rods above described may be obtained upon an input by action of forces generated by solid elements or/and inflatable components or other equivalents, or by means of a pressurized liquid. In the case described in FIGS. 5, 7 the expanding rods have in particular a geometry such to maintain in absence of any force or geometric constrains a divergent shape like in FIGS. 5, 7, while, if under force action or/and geometric constrains obtained retrieving said expanding rods by sliding into the tube (5a) of the holding-releasing device, said expanding rods bend converging under the force action generated by the geometric constrain caused by said tube as shown in FIG. 3.

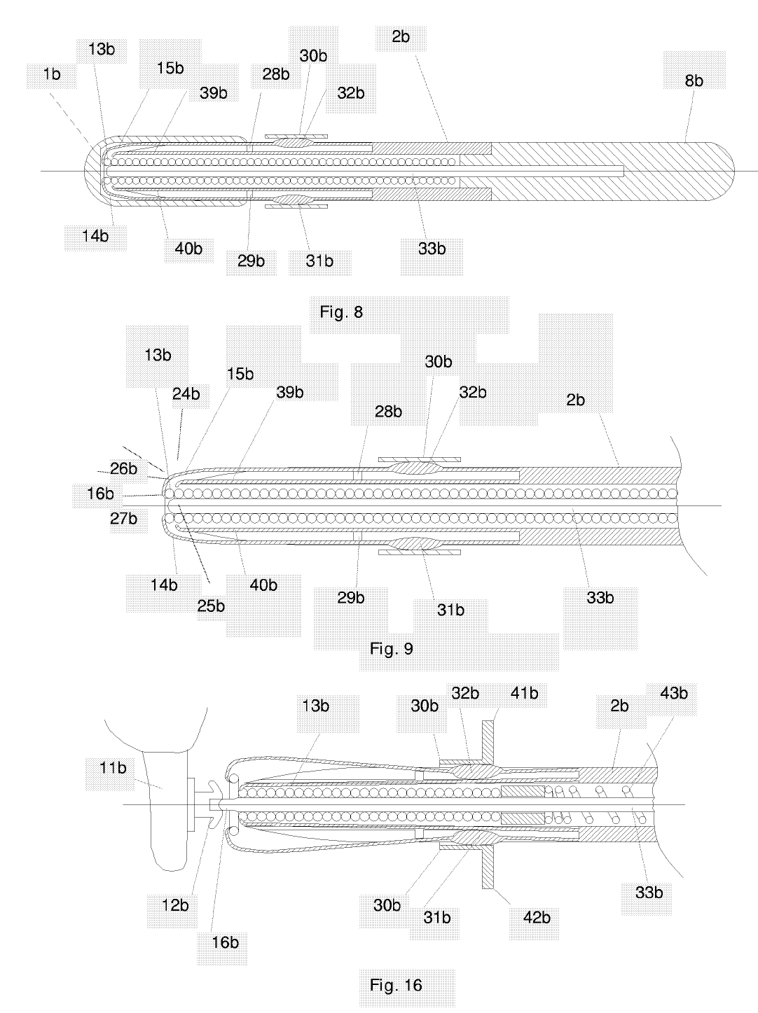

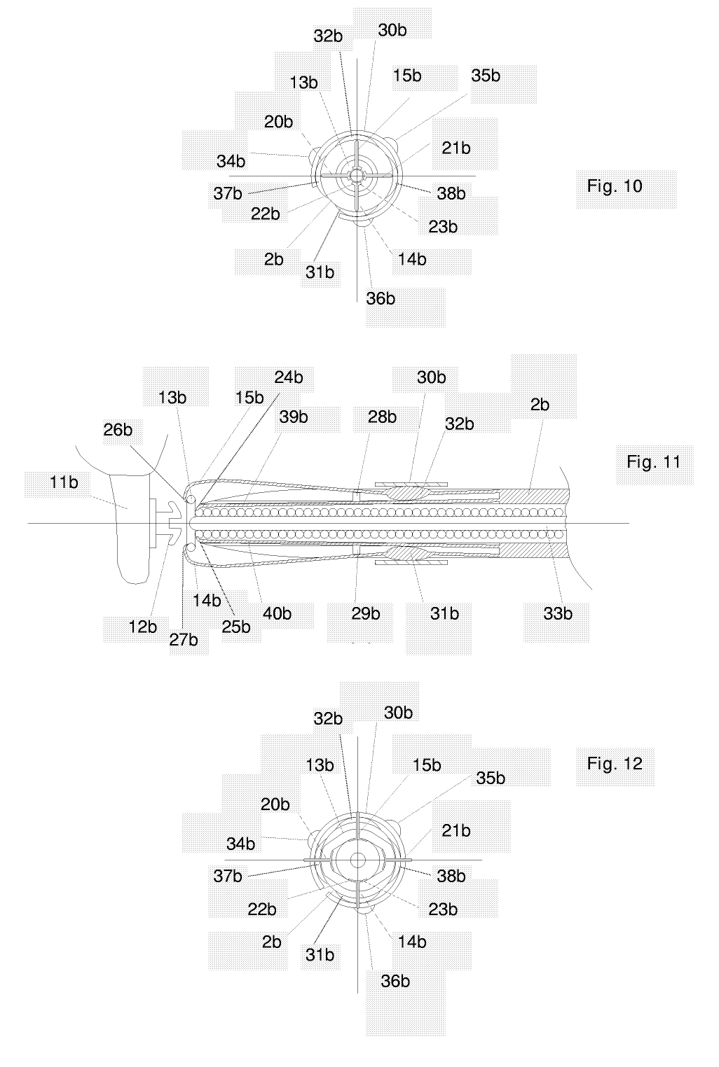

A second embodiment of the invention, obtained as a variant of the first embodiment, is shown in FIG. 8. The elastics (13b), generally with an o-ring shape and made of an elastic colored material, are housed in the container, said container housing a plurality of elastics. Said container (33b) comprises a rod and said elastics are threaded by said rod so that the elastics (13b) can slide along said rod if pushed by means like springs, like in FIG. 16, pressured air or gas in general, including also the specific case shown in FIG. 8 where the elastics can slide along said rod simply by means of the force of gravity. The container is designed to not allow any elastic to exit if not requested. In this specific case, shown in FIGS. 8 and 9, the elastics can not exit due to the fact that on one side of the rod there is a physical barrier realized by the cover (8a) that does not allow the elastics to slide any further along that direction. On the other side of said rod, as shown in FIG. 9 there is the holding-releasing device and in particular there are the expanding rods (15b) (14b) (20b (21b) shown in FIG. 10, where said expanding rods are designed with a proper geometry and positioned in order to realize a physical barrier to not allow any elastic to exit from the container as shown in FIG. 9.

The holding-releasing device releases upon an input the elastics allowing them to slide to the elastic placer from the elastic container. Said holding-releasing device comprises a barrier/s that physically dos not allow elastics to slide any further and than does not allow the elastics to exit from the container. In this specific case said barrier/s is realized by the one or more expanding rods (14b) (15b) as shown in FIG. 9, where said rods are physically blocking the elastics by the block/s (26b) (27b) preventing the elastics to slide any further in that direction. Elastics can slide until the first elastic goes to contact to said block/s (26b) (27b) and said sliding action can be obtained by pushing with spring/s pressured air or gas in general or any other device or mechanism suitable to this scope including also the case where elastics slides by means of the force of gravity. When an elastic (13b) goes to contact to the barrier/s (26b) (27b) as shown in FIG. 9, said elastic is also loaded in the elastic placer device. The barrier/s (26) (27), upon an input can be removed as shown in FIG. 11, allowing the expulsion of the elastic (13b) to engage and be applied to the bracket (12b). Said barrier/s (26b) (27b) can move due to the movement and/or bending of the expanding rods (14b) (15b) (20b) (21b) where said movement or bending can be obtained, for instance, by finger pressure to the push button (30b), said push button transferring the related force to the pressure elements (32b) (31b) causing the combined action of bending and rotation of the expanding rods with rotation having the rotation points corresponding to the fulcrums (28b) (29b), action that causes the extremity of the expanding rods and relative barrier/s to move away relatively one from each other. In particular, while the expanding rods and so the related block/s are removed, upon an input, basically at the same time other barrier/s (24b) (25b) do not allow the remaining elastic to exit from the elastic container as shown in FIG. 11. Said barrier/s (24b) (25b) physically stop the passage not allowing the remaining elastics to slide any further in that direction and, said barriers, may be activated, for instance, by one or more retaining rods (39b) (40b) or, alternatively said barrier/s may be included in said rods to be only one part with the retaining rods themselves. The retaining rods may move or elastically bend in action under an action of generic forces like, for instance, the finger pressure to the push button (30b), said push button transferring the force by contact to the pressure element/s (31b) (32b) and so, by contact, transferred to the retaining rod/s (39b) (40b). Once the pressure to the push button is not longer in action , the barrier/s (24b) (25b) (26b) (27b), the expanding rods and the retaining rods return all back to the original configuration and position shown in FIG. 9 due to the elastic energy of return of the material of which said parts are made of. Alternatively, the action of said barrier/s (24b) (25b) (26b) (27b) may be activated and/or removed by action of spring/s, air pressured or gas devices in general. In addition, said barrier/s may be solid or made of inflatable components or other equivalents, or by means of a pressurized liquid. In addition, as an option said barrier/s may be realized of or comprising a substrate of adhesive material in order to increase the grip. Obviously, for a person skilled in the field, all combinations of the above described versions and embodiments may merge in other and different embodiments without departing from the scope of the present invention.

The elastic placer device is realized by the expanding rods (14b) (15b) end eventually by the center-position-alignment rod (16b), said last rod suitable for centering, positioning and aligning properly the apparatus relative to the bracket (12b) as shown in FIGS. 9, 11, 16. The expanding rods (14b) (15b), upon an input, expand and/or move away relative one from the others and, in this way, as shown in FIG. 9, said rods are also expanding the elastic, diverging it as necessary in order to allow said elastic (13b) to engage to the bracket (12b) and in particular to the recesses between the base (30) and/or body and the tie wings (28) (29) of said bracket as shown in FIG. 13. While the elastic is being diverged, the remaining elastics are kept in the container as shown in FIG. 11 by means of barrier/s (24b) (25b) where said barrier/s or block/s, in this specific case, are realized by the extremity of the retaining rods. The diverging and expanding action of the expanding rods (14b) (15b) (20b) (21b) is against the retrieving and elastic action of the elastic that makes the elastic to attempt to return back to the original and relaxed configuration so that the elastic makes the rods bending to the limit point where the two opposite actions balance themselves and/or the barrier/s 26b) (27b) on the expanding rod/s are not able to held any longer the elastic so that, said elastic, is expelled to the bracket direction and engages to the recesses between the base (30) and the tie wings (28) (29) of the bracket (12) while all other elastics are instead kept safely in the container by the action of the barrier/s (24b) (25b). Once the elastic is being expelled, the expanding or the diverging movement of the extremity of the expanding rods stop and begins the retrieving action or converging movement of the expanding rods and, basically at the same time, the retaining rods are also starting to recuperate the original position as shown in FIG. 9 allowing again the passage and the elastics to slide from the container so that the next elastic is loaded in the elastic placer in order to be in an analog manner applied to the next bracket.

The expanding-retrieving action or diverging-converging movement of the expanding rods and of the related barrier/s and of the retaining rods may be realized, for instance, by finger pressure of the push button as shown in the FIGS. 10, 11, 12. The push button (30b) presents a substantially annular shape and includes the handling points (34b) (35b) (36b) to facilitate the handling in action of the apparatus. Pushing said push button, it bends elastically transferring the force by contact to the pressure elements (31b) (32b) (37b) (38b), said pressure elements transferring that force by contact to the expanding rods and to the retaining rod/s, said rods all moving under that force their related and associated barrier/s to obtain the requested expanding, retrieving and retaining functionality above described. Alternatively, the force action to the pressure elements may be realized by sliding upon an input the button (30b) to the (A) direction shown in FIG. 2 to the bracket and/or in the opposite direction as shown in FIG. 16 where, pushing for instance the wings (41b) (42b), said button (30b) slides consequently to the same direction resulting no longer pushing to the pressure elements (31b) (32b), while pushing back to the opposite direction the button (30b) return to push again to the pressure elements as in FIG. 16. In an analog manner, once the first elastic is being applied to the first bracket , it is possible to proceed in the same way to move the next elastic from the container to the elastic placer and, after that, to expel and apply said next elastic and so on for the application to brackets of all remaining elastics.

Eventually, the ending part of rod of the container (16b) in FIGS. 9, 16 may be used to center, position and align the apparatus relative to the bracket as shown in FIGS. 11, 16 to facilitate and for more reliable elastic application to the designated bracket similarly as described for the first embodiment of the invention.

In addition, as shown in FIG. 8, the housing of the elastic container may be substantially linear or, alternatively, if needed, not shown in any figure, said housing may be curvilinear to facilitate the elastic application to those brackets are presenting a difficult access, in a similar way as described for the first embodiment of the invention.

In addition, as shown in FIG. 12, the expanding rods (14b) (15b) (20b) (21b) may expand the elastic, said elastic maintaining an elliptical shape or a circular shape depending on the shape of the bracket (12) and its tie wings (28) (29) as described for the first embodiment of the invention. In addition, if necessary, as shown in FIGS. 10, 12, one, part or all expanding rods may include radial elements (22b) (23b) in order to expand the elastic, said elastic preserving in action an elliptic or circular shape.

The apparatus includes also a safety cover (1b) as shown in FIG. 8 to avoid to accidentally drop an elastic by pressing the push button and to guarantee the due hygienic conditions of the various devices of the apparatus during transportation, storage and in general when is not used.

In addition, said safety cover (1b) may include proper substance suitable for cleaning and maintaining the various devices like, for instance, the expanding rods (14b) (15b) (20b) (21b), and, in particular, said safety cover may include a pad impregnated of said proper substance or, not shown in any figure, it may be used a container with a dispenser in order to release said proper substance, for instance, by means of nozzles.

In addition, the apparatus may be a disposable tool or reusable by means of cartridges housing the elastics, said cartridges preloaded of elastics or loadable of elastics. An example of a cartridge may be obtained looking FIG. 8. In particular, the cover (8b), the rod of the elastic container (33b) and a longer safety cover respect the safety cover (1b) to work as cover of the cartridge closing the cartridge in a similar way like provided by the chassis (2b) of the apparatus, are realizing an assembly that is an example of cartridge housing the elastics (13b). To load the cartridge in the apparatus it may be removed the assembly realized with the cover (8b), the rod of the container (33b), the chassis (2b) of the apparatus and, after that, the cartridge, once is removed the safety cover of the cartridge, is interfaced with the apparatus and in particular, in this case, with the chassis (2b) so that said cartridge becomes in real fact the new cover (8b) and the new rod (33b) of the elastic container as shown in FIG. 8. Alternatively, a an example of cartridge may be obtained looking FIG. 17. In this case, once removed the cover (4c) from the cartridge in FIG. 17 and removed also the carter (2b) and the cover (1b), the apparatus may be inserted in the cartridge so that the rod of the container (33b) threads the elastics are in the cartridge loading in this way said elastics into the housing of elastic container of the apparatus. After that, assembling again the carter (2b) and the cover (1b) is obtained again the same configuration shown in FIG. 8. Alternatively, an example of a cartridge may be obtained looking FIG. 18 where the elastics are threaded in the cartridge by the rod (33d) and held by the blocks (1d) (8d) at the extremities of said rod (33d). In case, the block (1d) may be, if needed, the cover (1c) shown in FIG. 17. In these cases it may be removed from the apparatus the assembly realized by the carter (2b) closed by the cover (1b) and, after that, the elastics are loaded in the elastic container of the apparatus by means of the cartridge and than, this assembly is used in an analog manner like the cover (1c) in FIG. 17 to load the elastics in the apparatus in a similar way as described in the previous example of cartridge or, optionally, if the rod (33d) and the cover (8d) are similar to the rod (33b) and cover (1b) of the apparatus, it is enough removing said last mentioned parts from the apparatus to change them directly with the cartridge itself inserting with the elastics also the assembly (33d) (8d) that, in real fact, are going to be the new rod (33b) of the elastic container and the new cover (8b) of the apparatus shown in FIG. 8.

In addition, said apparatus may be realized in general of any suitable material and/or color including also the case where all or part of it may be transparent so that it is possible to see if the apparatus or/and the optional cartridge houses elastics, how many, type and color of said elastics as well.

In an alternative version of the second embodiment, not shown in any drawing, the functionality of the barrier/s (24b) (25b) (26b) (27b) of the expanding rods (15a) (14a) (20a) (21a) and related mechanism of the push button (30b) of the apparatus to move release and hold the elastics described in the second embodiment may be realized by means of rods retrieved, expanded and pushed by air pressured or gas in general or in combination with spring/s such to create the retrieving action while the air pressured or gas create the expanding action of said expanding rods or vice versa.

In addition, the action of the barrier/s and of the expanding rods above described may be obtained and/or removed upon an input by action an forces generated by solid elements or/and inflatable components or other equivalents, or by means of a pressurized liquid.

Obviously, there may be many other preferred embodiments, for instance combining the various examples of the above described embodiments of the invention or other more that may appear obvious for a skilled person in the field without departing from the scope of the present invention. The foregoing disclosure and description of the invention is illustrative and explanatory thereof. Various changes in the details of the illustrated construction may be made without departing from the scope of the appended claims.

1-49. (canceled)

50. An apparatus for applying orthodontic elastics to orthodontic brackets, said apparatus comprising:
a container chassis defining a housing;
a tube-shaped member positioned within the housing, the tube-shaped member having an external circumferential surface, an internal surface spaced from a longitudinal axis, and an open end, the circumferential surface extending longitudinally to carry a plurality of elastics thereabout; and
a plurality of rods slidingly disposed within the tube-shaped member, each rod having a free extremity movable beyond the open end to carry an elastic received thereon for placement on a target orthodontic bracket.

51. The apparatus of claim 50, wherein the free extremities are positionable to a first position adjacent the open end to receive an elastic thereabout, and the rods are movable to move the free extremities forwardly and outwardly relative to the open end to expand an elastic received thereabout.

52. The apparatus of claim 51, wherein each free extremity is bent outwardly relative to the longitudinal axis and the tube-shaped member, such that the rod and the free extremity are movable inwardly in the tube-shaped member to cause the plurality of free extremities to converge inwardly and toward the longitudinal axis and such that the rod is movable outwardly in the tube-shaped member such that the plurality of free extremities are moved to diverge beyond the open end.

53. The apparatus of claim 51, wherein each rod includes a longitudinally extending linear portion and a free extremity that is bent to deviate from the linear portion, the rod being slidable inwardly into the tube-shaped member such that the open end urges the bent free extremity toward alignment with the longitudinal axis as the free extremity is moved to the first position.

54. The apparatus of claim 53, wherein the plurality of free extremities are retractable from a position beyond the open end to the first position proximal the open end to collectively receive an elastic from the circumferential surface.

55. The apparatus of claim 54, wherein the rod is movable, from a substantially receded position corresponding to the first position of the free extremity, forwardly toward a second position to urgingly expand an elastic supported about the free extremity.

56. The apparatus of claim 55, wherein the rods are retractable from a position corresponding to a position of the free extremities forward of the open ends to the receded position to receive an elastic from the circumferential surface.

57. The apparatus of claim 56, wherein the circumferential surface is adapted to carry a plurality of elastic in sequential arrangement, the open end being in alignment with the free extremities in the first position such that an elastic supported adjacent the open end is movable from the circumferential surface to the free extremities.

58. The apparatus of claim 51, further comprising bias means positioned adjacent the tube-shaped member in engagement with an arrangement of elastics carried thereabout to bias the elastics forwardly toward the open end.

59. The apparatus of claim 51, further comprising a plunger engaged with a second end of the rods, the plunger being operable to initiate forward movement of the rods to expand and carry an elastic received about the free extremity.

60. The apparatus of claim 51, further comprising means for aligning an elastic carried by the free extremities relative to a target bracket, the aligning means including a spacer positionable with the free extremities to contact the target bracket.

61. The apparatus of claim 51, wherein the free extremity includes a movable barrier positionable between the circumferential surface and the free extremity to restrict forwardy passage of an elastic from the circumferential surface to the free extremities.

62. The apparatus of claim 51, further comprising a releasing mechanism including a movable barrier on each free extremity positionable between the free extremity and the circumferential surface to restrict forwardly passage of an elastic from the circumferential surface, the movable barrier being movable from a position corresponding to the first position of the free extremity end to selectively release an elastic from the circumferential surface to the free extremity.

63. The apparatus of claim 62, wherein the movable barrier is movable inwardly into the tube-shape member clear passage of an elastic from the circumferential surface to the free extremities.

64. The method of claim 62, wherein the free extremities each include an arc-shaped end configured to receive an elastic thereabout.

65. An apparatus for applying orthodontic elastics to orthodontic brackets, said apparatus comprising:
a container chassis defining a housing;
a tube-shaped member positioned within the housing, the tube-shaped member having an external circumferential surface, an internal surface spaced from a longitudinal axis, and an open end, the circumferential surface extending longitudinally to carry a plurality of elastics thereabout; and
an elastic placer operable to receive an elastic from the circumferential surface and forwardly movable to apply an expanded elastic to a target orthodontic bracket, the elastic placer including a plurality of slidable rods situated within the tube-shaped member; and
wherein each rod include a free extremity, the plurality of free extremities being positionable proximal the open end to receive an elastic from the circumferential surface as the rod is slidably received within the tube-shaped member and movable forwardly from the open end as the rod is moved outwardly within the tube-shaped member, the free extremities being outwardly biased relative to the open end such that the free extremities diverge outwardly to expand an elastic recede thereabout as the free extremities are moved forwardly beyond the open end.

66. The apparatus of claim 65, further comprising a releasing mechanism including a movable barrier on each free extremity positionable between the free extremity and the circumferential surface to restrict forwardly passage of an elastic from the circumferential surface, said movable barrier being movable from a position proximal the open end to selectively release an elastic from the circumferential surface to the free extremity.

67. A system for applying orthodontic elastics to orthodontic brackets, said system comprising:
an elastic container having an elastic housing defined therein, said elastic housing being configured to house a plurality of elastics; and
an elastic placer engageable with said elastic housing to selectively receive an elastic from said elastic container, wherein said elastic placer is disengageable from said elastic container and operable to apply the received elastic to a target bracket.

68. The apparatus of claim 67, further comprising a dispenser for applying a suitable cleaning and preserving substance, said dispenser being engageable with said elastic placer to release in use said substance.

69. The apparatus of claim 67, further comprising at least a cartridge engageable with said elastic container to load said elastic container with a plurality of elastics.
